(19) United States
(12) Patent Application Publication
(10) Pub. No.: US 2008/0258850 A1
(43) Pub. Date: Oct. 23, 2008

(54) Switching Device Having an Electromagnetic Release

(75) Inventors: Patrick Claeys, Darmstadt (DE); Albrecht Vogel, Stutensee (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/663,961

(22) PCT Filed: Nov. 15, 2005
(86) PCT No.: PCT/EP05/12191

§ 371 Date: Mar. 28, 2007

(30) Foreign Application Priority Data
Nov. 22, 2004 (DE) 10 2004-056 281.4
Nov. 22, 2004 (DE) 10 2004 056 282.2
Nov. 22, 2004 (DE) 10 2004 056 283.0

(51) Int. Cl. H01H 75/12

(52) U.S. Cl. 335/36

(57) ABSTRACT

The invention relates to switching equipment comprising a housing, at least one contact point that has at least one fixed and one mobile contact part and an electromagnetic trip device, comprising a trip coil and a hammer armature. Said equipment is wherein the electromagnetic trip device comprises a snap body consisting of a material with magnetic shape memory properties, which interacts with the hammer armature. According to the invention, when a short-circuit occurs, the snap body is switched between two bi-stable positions by the influence of the magnetic field of the trip coil.

The invention relates to a switching device having a housing and having at least one contact point, which comprises a fixed and a moveable contact piece, and having an electromagnetic release, which has a tripping coil and an impact armature, in accordance with the precharacterizing clause of claim 1.

In generic switching devices, for example line circuit breakers or motor circuit breakers, the electromagnetic release is used for interrupting the current path between the input and output terminals in the event of the occurrence of a short-circuit current. The electromagnetic releases known nowadays in the prior art, such as are described, for example, in DE 101 26 852 C1 or DE 100 10 093 A1, in this case all function on the basis of the principle that a tripping armature caused to move towards a magnet core in the event of the occurrence of a short-circuit current and, in the course of this movement, the tripping armature, via a plunger which is operatively connected to it, forces the moveable contact piece away from the fixed contact piece at the contact point, with the result that the contact point is opened. With the same movement, a latching point in a switching mechanism which is coupled to the moveable contact point is also unlatched, with the result that the contact point is permanently opened hereby. Known electromagnetic releases comprise for this purpose a coil, which is generally produced from helically wound wire, and a magnet core, which is fixedly connected to a yoke surrounding the coil on the outside and engages in the interior of the coil. The tripping armature is either in the form of a hinged armature or in the form of a plunger-type armature, the latter likewise being located within the coil. The armature is held at a distance from the core in the rest state by means of a compression spring. If the short-circuit current flows through the tripping coil, the magnetic field induced in the process in the tripping coil results in the tripping armature being moved towards the core counter to the resetting force of the compression spring. Once the short-circuit current has been switched off, the armature is moved back into its initial position again by the resetting force of the compression spring.

It is therefore the object of the present invention to design a generic switching device in a manner which is simpler to fit and therefore more cost-effective.

The object is achieved by a switching device having the characterizing features of claim 1.

According to the invention, the electromagnetic release therefore comprises a snap-action body, which, in accordance with one first embodiment, is operatively connected to the plunger and consists of a material having a magnetic shape memory effect, the snap-action body, under the influence of the magnetic field of the tripping coil in particular in the event of a short-circuit current, being switched over into two bistable positions. In particular, the snap-action body can be formed from a ferromagnetic shape memory alloy consisting of nickel, manganese and gallium.

Releases which comprise a snap-action body are today exclusively known in the prior art as thermal releases, whose operation is based on the snap-action disk principle. The snap-action disk is in this case a disk-shaped component having a curvature in a first direction. Under mechanical deformation stress, the curvature suddenly changes its alignment from its first bistable position to its second bistable position, from convex to concave or vice versa, when a dead center point—which is dependent on the spring-elastic component parameters—is exceeded. The known snap-action disks may be produced from a bimetallic strip or thermal shape memory alloys, for example Ni—Ti.

Electrical line circuit breakers, motor circuit breakers or power circuit breakers also have, in addition to an electromagnetic release, a thermal release which, in the case of known releases, is in the form of a bimetallic strip, which bends out under the influence of a temperature increase owing to an overcurrent and, in the process, unlatches the switching mechanism of the switching device, as a result of which the contact point is opened permanently. In place of such bimetallic strips, strips consisting of a shape memory alloy have also become known.

The invention makes use of the fact that magnetic shape memory alloys (see further below) also have a thermal shape memory effect, which is combined with the magnetic shape memory effect, with the result that the snap-action body, both under the influence of the magnetic field of the tripping coil and under the influence of a temperature increase brought about by overcurrent, is switched over into two bistable positions. In this case too, the snap-action body may be formed from a ferromagnetic shape memory alloy consisting of nickel, manganese and gallium.

In the case of magnetic shape memory alloys, a change in shape may be brought about in the martensitic phase owing to the transition between two crystal structure variants of a twin-crystal structure, in which case the transition between the crystal structure variants is controlled by an external magnetic field. The magnetic field strength at which this phase transition takes place will also be referred to below as “transition field strength”. These materials are therefore referred to as magnetic shape memory alloys (MSMs).

Magnetic shape memory alloys are advantageously in the form of ferromagnetic shape memory alloys consisting of nickel, manganese and gallium. More precise explanations in relation to the design and function of ferromagnetic shape memory alloys on the basis of nickel, manganese and gallium can be gleaned, for example, from WO 98/08261 and WO 99/45631.

By means of the corresponding alloy composition it is possible to determine at which orientation of the external magnetic field the maximum expansion is achieved; for example the magnetic field may be at right angles to or transverse to the MSM material in order to reach the maximum expansion.

Changes in shape which are achieved by MSM materials under the effect of an external magnetic field may be linear expansion, bending or torsion.

In the case of MSM materials, in addition to the magnetically stimulated transition, a thermally stimulated transition also takes place between the martensitic and austenitic phase.

If the external magnetic field is small, these materials behave as a conventional thermal shape memory metal. In this case, the two shapes between which the change in shape takes place are formed in different phases of the material in a known manner: a martensitic phase below and an austenitic phase above a so-called transition temperature of the material. If the material temperature exceeds the transition temperature, the phase transition takes place, which brings with it the change in shape. In this case, the thermal transition temperature can be determined by the corresponding alloy composition and can therefore be matched to the respective application.

In the case of MSM materials, one of the abovementioned changes in shape can therefore be brought about below the transition temperature, in the low-temperature or martensitic phase, exclusively by applying an external magnetic field. Without an external magnetic field, or in the case of a very small external magnetic field, the change in shape takes place in a thermally induced manner when the temperature exceeds or falls below the transition temperature.

An electromagnetic release according to the invention comprises a snap-action disk consisting of an MSM material having a suitable composition. The magnetic field is induced by a coil through which current flows.

The change in shape of the MSM material takes place proportionally to the coil current in the case of a low current strength. The snap-action disk is located in its first bistable position in the untripped state. In terms of its spring-elastic design, it is dimensioned such that, in the event of a specific transition magnetic field strength being exceeded which is reached in the case of a specific short-circuit current through the coil, it has just exceeded its dead center point and suddenly moves over to its second bistable position.

The advantage of the invention consists in the fact that, in the case of a switching device according to the invention, the design of the magnetic release is significantly simplified. The magnetic release according to the invention can be realized in a more compact and space-saving manner than a magnetic release in accordance with the prior art. A switching device according to the invention having a magnetic release according to the invention can therefore also have a simpler and more compact design.

A thermal and electromagnetic release according to the invention in accordance with a second embodiment comprises a snap-action disk consisting of an MSM material, which has a suitable composition and has a thermal shape memory effect without a magnetic field or in the presence of only a small magnetic field and a magnetic shape memory effect below the thermal transition temperature in the presence of a high magnetic field. In this case, the magnetic field is induced by a coil through which current flows and whose thermal radiation also brings about the change in temperature in the snap-action disk in the event of a current flow.

The advantage of the invention consists in the fact that, in the case of a switching device according to the invention, both tripping principles, namely the thermal tripping principle and the electromagnetic tripping principle, are realized in a single tripping element having a low degree of complexity. The design of a thermal and magnetic release is therefore significantly simplified. The thermal and magnetic release according to the invention can also be realized in a significantly more compact and space-saving manner than a combination of two separate thermal and magnetic releases in accordance with the prior art. A switching device according to the invention having a thermal and magnetic release according to the invention can therefore also have a simpler and more compact design.

The snap-action disk is located in its first bistable position in the untripped state. In terms of its spring-elastic design, it is dimensioned such that, below the thermal transition temperature in the event of a specific transition magnetic field strength being exceeded which is in turn reached in the case of a specific short-circuit current through the coil or, given only a small magnetic field, in the event of a specific transition temperature being exceeded which is reached when a specific overcurrent through the tripping coil is exceeded, it just exceeds its dead center point and suddenly moves over to its second bistable position.

In both embodiments of the invention, the following further features are provided:

One further advantage of a switching device according to the invention is the high speed of the magnetic tripping. No inert masses need to be accelerated, and the change in shape owing to the thermal and magnetic shape memory effect takes place virtually without delay.

One further advantage of a release according to the invention in this case consists in the fact that, owing to the snap-action disk principle, it trips with a high degree of accuracy and is not very sensitive to fabrication spread both of the mechanical tolerances and the material composition. Since only few parts are required, only a small amount of physical space is required in the housing.

In this case too, the abovementioned advantages are also displayed:

One advantage of a switching device according to the invention consists in the fact that the physical assignment of the tripping coil to the snap-action body consisting of a ferromagnetic shape memory metal can be matched in a variety of ways to the geometrical requirements within the switching device housing.

The snap-action body in accordance with the two embodiments may be in the form of a snap-action disk and be held in its edge region in a snap-action body mount, which is connected to the housing. In one advantageous refinement, the snap-action body is in this case fitted outside the tripping coil in its vicinity.

In accordance with one further advantageous refinement, the snap-action body of the release according to the invention is in the form of a snap-action disk and is held within a coil former, which bears the tripping coil. The snap-action body is then advantageously surrounded by the tripping coil.

The snap-action disk can be connected, in its center, to the impact armature in a force-fitting or interlocking manner. In one advantageous refinement of the invention, the snap-action element is in this case operatively connected to a resetting spring, which assists in switching the snap-action element over into the two bistable positions.

Optimum utilization of space can therefore be achieved within the switching device housing, which results in smaller and therefore more cost-effective designs of the switching devices.

Fewer parts are required with a lower demand on their measurement accuracy for the thermal and electromagnetic release, and it is therefore simpler and less expensive to fit a thermal and electromagnetic release with a snap-action element consisting of a ferromagnetic shape memory metal.

A thermal and electromagnetic release according to the invention comprises a snap-action disk consisting of an MSM material, which has a suitable composition and has a thermal shape memory effect without a magnetic field or in the presence of only a small magnetic field and a magnetic shape memory effect below the thermal transition temperature in the presence of a high magnetic field. In this case, the magnetic field is induced by a coil through which current flows and whose thermal radiation also brings about the change in temperature in the snap-action disk in the event of a current flow.

The advantage of the invention consists in the fact that, in the case of a switching device according to the invention, both tripping principles, namely the thermal tripping principle and the electromagnetic tripping principle, are realized in a single tripping element having a low degree of complexity. The design of a thermal and magnetic release is therefore significantly simplified. The thermal and magnetic release according to the invention can also be realized in a significantly more compact and space-saving manner than a combination of two separate thermal and magnetic releases in accordance with the prior art. A switching device according to the invention having a thermal and magnetic release according to the invention can therefore also have a simpler and more compact design.

The snap-action disk is located in its first bistable position in the untripped state. In terms of its spring-elastic design, it is dimensioned such that, below the thermal transition temperature in the event of a specific transition magnetic field strength being exceeded which is in turn reached in the case of a specific short-circuit current through the coil or, given only a small magnetic field, in the event of a specific transition temperature being exceeded which is reached when a specific overcurrent through the tripping coil is exceeded, it just exceeds its dead center point and suddenly moves over to its second bistable position.

One further advantage of a switching device according to the invention is the high speed of magnetic tripping. No inert masses need to be accelerated, and the change in shape owing to the thermal and magnetic shape memory effect takes place virtually without delay.

One further advantage of a release according to the invention consists in the fact that, owing to the snap-action disk principle, it trips with a high degree of accuracy and is not very sensitive to fabrication spread both of the mechanical tolerances and the material composition. Since only few parts are required, only a small amount of physical space is required in the housing.

One further advantage of a switching device according to the invention consists in the fact that the physical assignment of the tripping coil to the snap-action body consisting of a ferromagnetic shape memory metal can be matched in a variety of ways to the geometrical requirements within the switching device housing.

The snap-action body may be in the form of a snap-action disk and be held in its edge region in a snap-action body mount, which is connected to the housing. In one advantageous refinement, the snap-action body is in this case fitted outside the tripping coil in its vicinity.

In accordance with one further advantageous refinement, the snap-action body of the release according to the invention is in the form of a snap-action disk and is held within a coil former, which bears the tripping coil. The snap-action body is then advantageously surrounded by the tripping coil.

The snap-action disk can be connected, in its center, to the impact armature in a force-fitting or interlocking manner. In one advantageous refinement of the invention, the snap-action element is in this case operatively connected to a resetting spring, which assists in switching the snap-action element over into the two bistable positions.

Optimum utilization of space can therefore be achieved within the switching device housing, which results in smaller and therefore more cost-effective designs of the switching devices.

Fewer parts are required with a lower demand on their measurement accuracy for the thermal and electromagnetic release, and it is therefore simpler and less expensive to fit a thermal and electromagnetic release with a snap-action element consisting of a ferromagnetic shape memory metal.

It is naturally also possible to produce a snap-action disk release in a third embodiment. According to this embodiment, the thermal and electromagnetic release comprises two snap-action bodies which are operatively connected to the plunger, one snap-action body consisting of a material having a magnetic shape memory effect, and the other snap-action body consisting of a bimetallic strip or of a material having a thermal shape memory effect or likewise of a material having a combined thermal and magnetic shape memory effect, which material has a different composition than that of the first snap-action body. Then, one, first snap-action body, under the influence of the magnetic field of the tripping coil in the event of a short-circuit current, and the other snap-action body, under the influence of a change in temperature brought about by overcurrent, are switched over into two bistable positions. In particular, one, first snap-action body can be formed from a ferromagnetic shape memory alloy consisting of nickel, manganese and gallium.

If the external magnetic field is small, these materials behave as a conventional thermal shape memory metal. In this case, the two shapes between which the change in shape takes place are formed in different phases of the material in a known manner: a martensitic phase below and an austenitic phase above a so-called transition temperature of the material. If the material temperature exceeds the transition temperature, the phase transition takes place, which brings with it the change in shape. In this case, the thermal transition temperature can be determined by the corresponding alloy composition and can therefore be matched to the respective application.

In the case of MSM materials, one of the abovementioned changes in shape can therefore be brought about below the transition temperature, in the low-temperature or martensitic phase, exclusively by applying an external magnetic field. Without an external magnetic field, or in the case of a very small external magnetic field, the change in shape takes place in a thermally induced manner when the temperature exceeds or falls below the transition temperature.

A thermal and electromagnetic release according to the invention comprises a first snap-action disk consisting of an MSM material, which has a suitable composition and has a magnetic shape memory effect below the thermal transition temperature in the presence of a high magnetic field. In this case, the magnetic field is induced by a coil through which current flows. The thermal transition temperature is adjusted by the material composition such that it is not exceeded at conventional operating temperatures.

A second snap-action disk consists of a bimetallic strip or of a material having only a thermal shape memory effect, or of an MSM material having a different composition, whose thermal transition temperature is adjusted by the material composition such that it is exceeded when an overcurrent flows through the tripping coil. In this case, the change in temperature of the snap-action disk is brought about by the thermal radiation of the tripping coil.

The two snap-action disks can in this case be operatively connected to one another such that, in the case of a transition of one of the two snap-action disks from the first bistable position into the second bistable position, the second snap-action disk also carries out this transition. The two snap-action disks can also be operatively connected to the impact armature separately, however.

The advantage of the invention consists in the fact that, in the case of a switching device according to the invention, both tripping principles, namely the thermal tripping principle and the electromagnetic tripping principle, are realized in a single tripping element having a low degree of complexity. The design of a thermal and magnetic release is therefore significantly simplified. The thermal and magnetic release according to the invention can also be realized in a significantly more compact and space-saving manner than a combination of two separate thermal and magnetic releases in accordance with the prior art. A switching device according to the invention having a thermal and magnetic release according to the invention can therefore also have a simpler and more compact design.

One further advantage of a release according to the invention consists in the fact that, owing to the snap-action disk principle, it trips with a high degree of accuracy and is not very sensitive to fabrication spread both of the mechanical tolerances and the material composition. Since only few parts are required only a small amount of physical space is required in the housing.

In one advantageous refinement, the two snap-action bodies can be fitted outside the tripping coil in its vicinity.

In accordance with one further advantageous refinement, the two snap-action bodies of the release according to the invention are held within a coil former, which bears the tripping coil. The two snap-action bodies can then advantageously be surrounded by the tripping coil.

Optimum utilization of space can therefore be achieved within the switching device housing, which results in smaller and therefore more cost-effective designs of the switching devices.

Fewer parts are required with a lower demand on their measurement accuracy for the thermal and electromagnetic release, and it is therefore simpler and less expensive to fit a thermal and electromagnetic release with a snap-action element consisting of a ferromagnetic shape memory metal.

Further advantageous refinements and improvements of the invention and further advantages are given in the further dependent claims.

The invention and further advantageous refinements of the invention will be explained and described in more detail with reference to the drawings, in which a few exemplary embodiments of the invention are illustrated and in which:

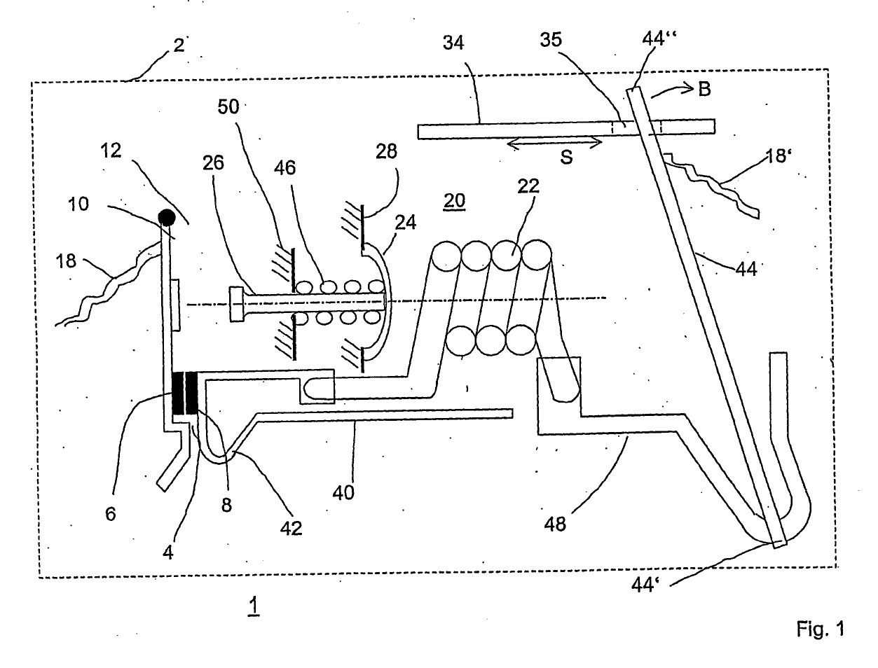

FIG. 1 shows a schematic illustration of a first embodiment of a switching device according to the invention having a snap-action body which consists of a ferromagnetic shape memory metal, is held in a snap-action body mount, which is connected to the housing, and is arranged adjacent to a tripping coil, in the rest state,

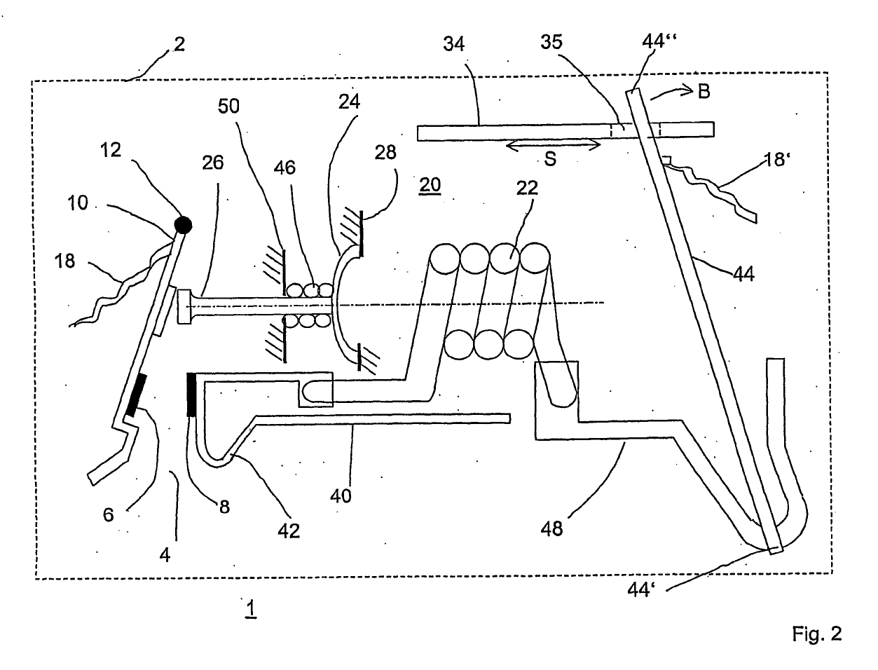

FIG. 2 shows a schematic illustration of the first embodiment shown in FIG. 1 in the tripped state,

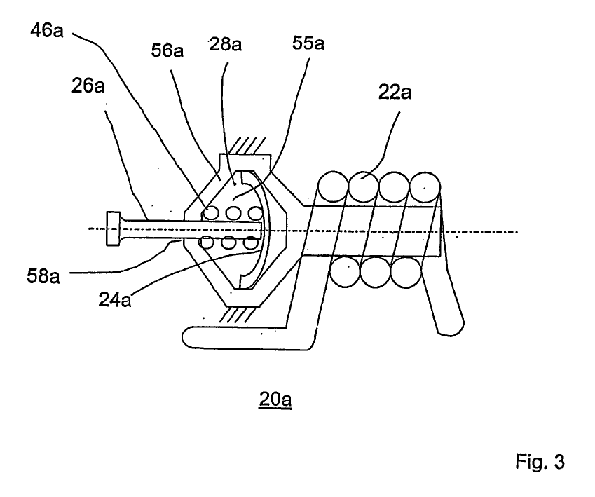

FIG. 3 shows a schematic illustration of a second embodiment of a release according to the invention having a disk-shaped snap-action body, which consists of a ferromagnetic shape memory metal, is arranged in the interior of a coil former, which bears the tripping coil, and is arranged adjacent to a tripping coil,

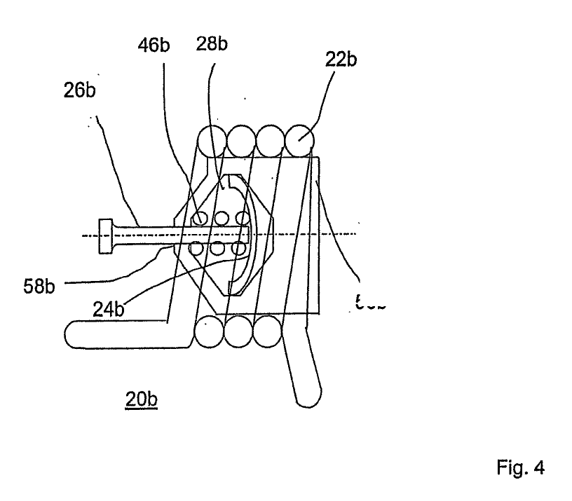

FIG. 4 shows a schematic illustration of a third embodiment of a release according to the invention having a disk-shaped snap-action body, which consists of a ferromagnetic shape memory metal, is arranged in the interior of a coil former, which bears the tripping coil, and is arranged in the interior of a tripping coil,

FIGS. 5 to 8 show further embodiments of a switching device without a bimetallic strip, in a similar illustration to those in FIGS. 1 to 4,

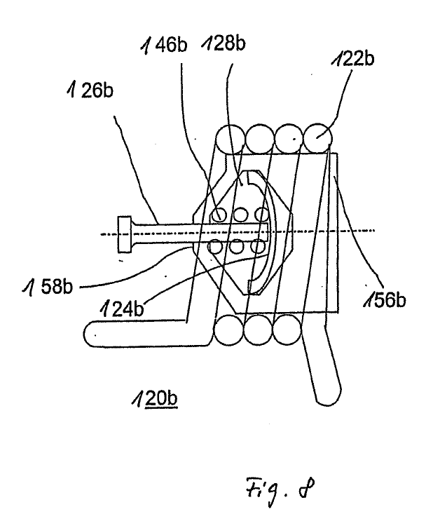

FIG. 9 shows a schematic illustration of a further embodiment of a switching device according to the invention having two snap-action disks, which are operatively connected to one another, one snap-action disk consisting of a ferromagnetic shape memory metal, arranged adjacent to a tripping coil, in the rest state,

FIG. 10 shows a schematic illustration of the embodiment shown in FIG. 9 in the tripped state,

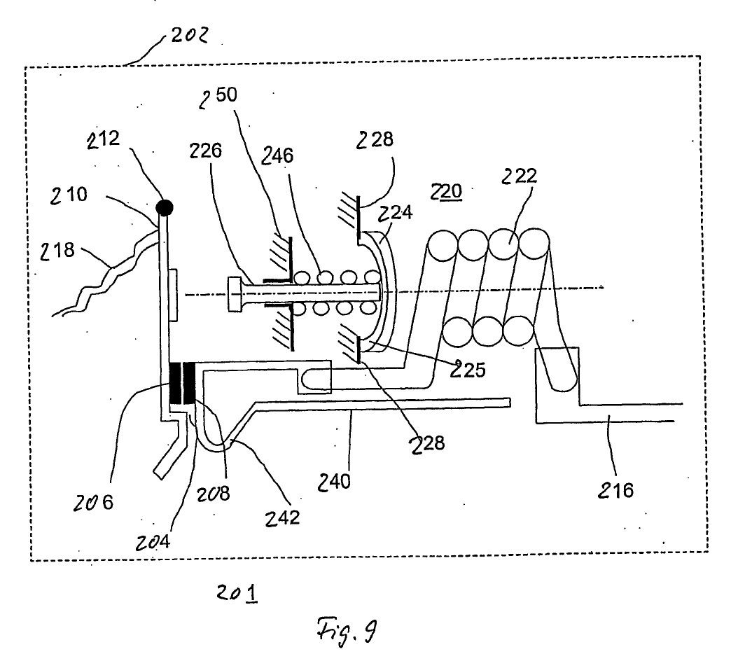

FIG. 11 shows a schematic illustration of a further embodiment of a release according to the invention having two snap-action disks, which consist of a ferromagnetic shape memory metal, are arranged in the interior of a coil former, which bears the tripping coil, and are operatively connected to one another, arranged adjacent to a tripping coil,

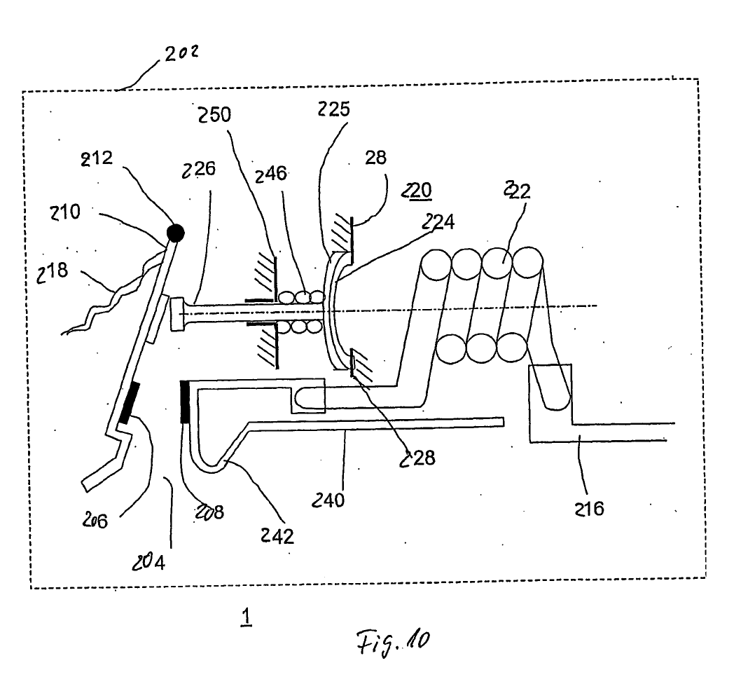

FIG. 12 shows a schematic illustration of a further embodiment of a release according to the invention having two snap-action disks, which consist of a ferromagnetic shape memory metal, are arranged in the interior of a coil former, which bears the tripping coil, and are operatively connected to one another, arranged in the interior of a tripping coil.

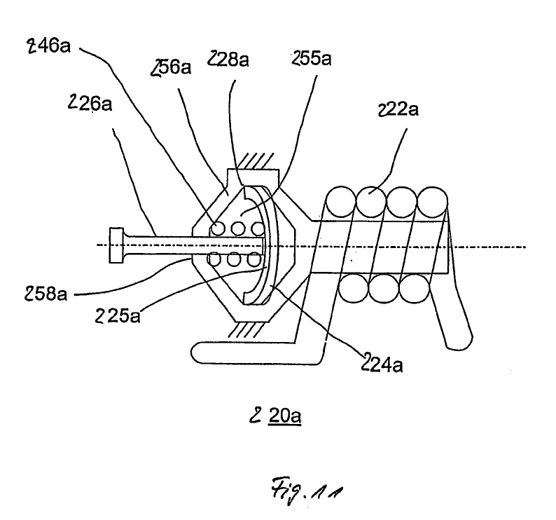

FIG. 13 shows a schematic illustration of a further embodiment of a switching device according to the invention having snap-action disks, which are each operatively connected to the impact armature separately, one snap-action disk consisting of a ferromagnetic shape memory metal, arranged adjacent to a tripping coil, in the rest state,

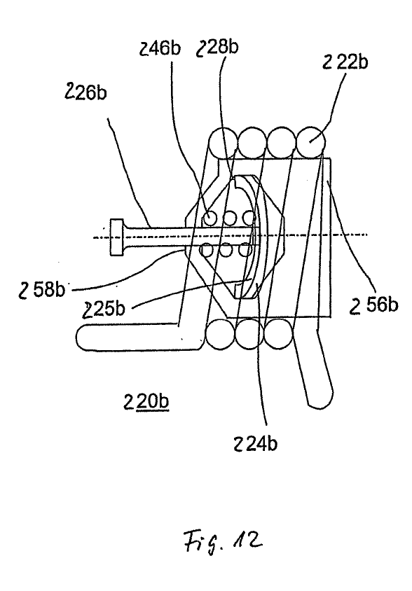

FIG. 14 shows a schematic illustration of the embodiment shown in FIG. 13 in the tripped state,

FIG. 15 shows a schematic illustration of a further embodiment of a release according to the invention having two snap-action disks, which consist of a ferromagnetic shape memory metal, are arranged in the interior of a coil former, which bears the tripping coil, are each operatively connected to the impact armature separately, and are arranged adjacent to a tripping coil, and

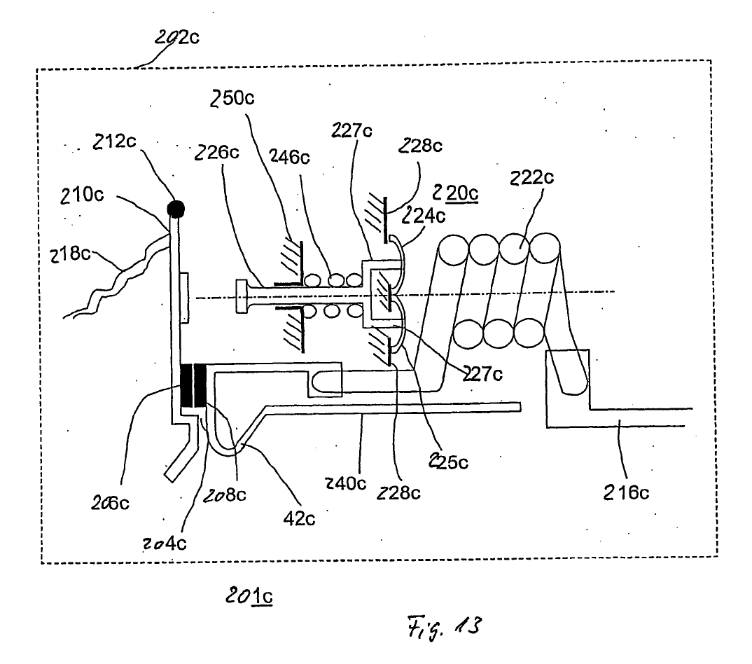

FIG. 16 shows a schematic illustration of a further embodiment of a release according to the invention having two snap-action disks, which consist of a ferromagnetic shape memory metal, are arranged in the interior of a coil former, which bears the tripping coil, are each operatively connected to the impact armature separately, and are arranged in the interior of a tripping coil.

FIG. 1 shows a schematic illustration of a switching device 1 having a housing 2 and an electromagnetic release 20 in the untripped state. FIG. 2 shows the switching device shown in FIG. 1 in the tripped state, in which case identical or functionally similar modules or parts are denoted by the same reference numerals.

In addition to the electromagnetic release 20, the switching device 1 also comprises a thermal overcurrent release. This is essentially formed from a bimetallic strip 44, which is fixed with its first, fixed end 44′ to a bimetallic holder 48, and whose second, moveable end 44d″ engages in a cutout 35 in a slide 34.

A current path runs between an input clamping piece (not illustrated here) and an output clamping piece (likewise not illustrated) via a moveable braided wire 18, a contact lever 10 mounted in a contact-lever mount 12, a contact point 4 comprising a moveable contact piece 6 located on the contact lever 10 and a fixed contact piece 8, a tripping coil 22, the bimetallic holder 48, the bimetallic strip 44 and a second moveable braided wire 18′. In the switching position shown in FIG. 1, the contact point 4 is closed. A yoke 40 is also connected to the tripping coil 22 and the fixed contact piece 8 via a lug-shaped intermediate piece 42.

The electromagnetic release 20 comprises the tripping coil 22 and a snap-action disk 24 formed from a ferromagnetic shape memory metal. This snap-action disk is arranged at the front end of the tripping coil 22 such that the snap-action disk center point moves on an imaginary line as an extension of the tripping coil longitudinal axis when it is snapped over. The snap-action disk 24 is held on its outer circumference in a snap-action disk mount 28, which is connected to the housing 2. In the untripped state shown in FIG. 1, its curvature points in the direction of the tripping coil 22. At its center point, the snap-action disk 24 is operatively connected to an impact armature 26. The operative connection is shown here as an interlocking connection, but force-fitting connections or connections produced by techniques such as soldering, bonding or welding could also alternatively be realized.

The snap-action disk consisting of a ferromagnetic shape memory metal based on nickel, manganese and gallium is located outside the tripping coil 22. Its physical arrangement in relation to the tripping coil 22 is selected such that good mechanical coupling to the tripping coil 22 is provided. A design of the tripping coil 22 and the magnetic circuit which is suitable for this purpose can be carried out by a person skilled in the art using his normal knowledge in the art and assisted by systematic experiments.

The snap-action disk 24 consists of a ferromagnetic shape memory alloy based on nickel, manganese and gallium. Such ferromagnetic shape memory alloys are known in principle and are available; they are produced and marketed, for example, by the Finnish firm AdaptaMat Ltd. A typical composition of ferromagnetic shape memory alloys for the use according to the invention in switching devices is provided by the structural formula Ni_{65-x-y}Mn₂₀₊ₓGa_{15+y}, where x is between 3 atomic percent and 15 atomic percent, and y is between 3 atomic percent and 12 atomic percent. The ferromagnetic shape memory alloy used here has the property that, in its martensitic phase, that is the phase which the material assumes below the thermal transition temperature, under the influence of an external magnetic field on a microscopic scale a transition between two crystal structure variants of a twin-crystal structure takes place which is macroscopically connected to a change in shape. In the embodiment selected here for the snap-action disk, the change in shape consists in a bend towards the shape of the second bistable snap-action disk position.

The thermal transition temperature in the case of the ferromagnetic shape memory alloys used here is in the region of the ambient temperature and can be adjusted by varying the atomic percent proportions x and y within a bandwidth. The working temperature range within which the electromagnetic release operates can therefore be adjusted within a bandwidth by selecting the material composition.

If a high short-circuit current flows through the switching device 1 in the event of a short circuit, the snap-action disk bends out of the first bistable position until the dead center point is exceeded, and the direction of curvature of the snap-action disk changes suddenly into the second bistable position. As a result, the plunger 26 forces the moveable contact piece 6 away from the fixed contact piece 8, with the result that the contact point 4 is opened and the switching device is tripped, as illustrated in FIG. 2. The bending of the ferromagnetic shape memory material takes place in this case very rapidly and virtually without any delay. The delay time as the time difference between the occurrence of the short-circuit current and the time at which the dead center point is reached is typically of the order of magnitude of one millisecond.

It is of course possible in this case for tripping to be assisted, as is conventional in switching device technology and is not illustrated here, by a tripping lever which actuates a switching mechanism ensuring the permanent opening of the contact point.

Once the switching device has been tripped, the current path is interrupted and the magnetic field of the tripping coil 22 breaks down again. As a result, the snap-action disk 24 is again moved back into its first bistable position, as a result of which the impact armature 26 is also moved back into the initial position again, as shown in FIG. 1. The contact point 4 is now held permanently in the open position by a switching mechanism.

In order to assist in the back-deformation of the snap-action disk 24 once the magnetic field of the tripping coil 22 has broken down as a result of the contact opening in the event of tripping, in the embodiment shown in FIGS. 1 and 2 a resetting spring 46 is fitted. In this case, this resetting spring is in the form of a helical spring and surrounds the impact armature 26. However, it could also be in the form of a leaf spring or have another suitable design. The resetting spring 46 is unstressed in the untripped state (FIG. 1). It is supported with one end on a spring mount 50, which is connected to the housing, and with its other end on the central section of the snap-action disk 24. In the event of tripping (FIG. 2), it is compressed by the snap-action disk 24, which has snapped into its second bistable position.

The switching device 1 in the embodiment shown in FIGS. 1 and 2 also comprises a thermal overcurrent release in addition to the electromagnetic release 20. This overcurrent release is essentially formed from a bimetallic strip 44, which is fixed with its first, fixed end 44′ to a bimetallic holder 48, and whose second, moveable end 44″ engages in a cutout 35 in the slide 34. In the event of an overcurrent, the bimetallic strip 44 bends in the direction indicated by the directional arrow B, with the result that the slide 34 is displaced in the direction of its longitudinal axis, indicated by the directional arrow S, and, via a line of action (not illustrated here), interacts with the switching mechanism (likewise not illustrated here), which then permanently opens the contact point 4. In the event of a short-circuit current, tripping by means of the electromagnetic release 20 takes place as described above.

FIG. 3 shows a further embodiment of a release 20a according to the invention for use in a switching device according to the invention. Identical or functionally identical components or modules are in this case denoted by the same reference numerals as in FIG. 1, in each case supplemented by the letter a.

The tripping coil 22a is in this case wound onto a cylindrical coil former. The coil former consists of a magnetically non-shielding material, for example of a ceramic or a suitable plastic. At its end facing the contact point, the coil former has a curvature in the form of a bulge such that, in its interior, a cavity 55a is produced, whose lateral boundary forms the snap-action body mount 28a and in which the snap-action disk 24a is accommodated and mounted. The impact armature 26a is guided such that it can slide in a bushing 58a at the front end of the coil former 56a which faces the contact point. The resetting spring 46a is likewise mounted in the interior of the cavity. The coil former 56a may comprise, for example, two halves which are split in the longitudinal direction along the central plane of the coil former, the snap-action disk with the resetting spring and the impact armature being inserted between the parts of said halves which form the cavity once they have been joined together, before the two halves are assembled to form the coil former 56a.

The coil former 56a is connected to the housing inner wall of the switching device such that it is fixed in position, with the result that the snap-action disk is in this case not mounted in the housing but in the interior of the coil former 56a. This results in a very compact tripping assembly with few individual parts.

One further embodiment of a release 20b according to the invention for use in a switching device according to the invention is shown in FIG. 4. Identical or functionally identical components or modules are in this case denoted by the same reference numerals as in FIG. 1 or 3, in each case supplemented by the letter b. The embodiment shown in FIG. 4 differs from that shown in FIG. 3 to the extent that, in the former case, the cavity 55b formed in the coil former 56b and therefore the snap-action disk 24b are located in the interior of the tripping coil 22b.

The exemplary embodiments described and illustrated in FIGS. 1 to 4 are an exemplary non-exclusive representation of possible switching devices according to the invention using an electromagnetic release having a snap-action body consisting of a ferromagnetic shape memory alloy. It is also possible for switching devices according to the invention to be produced from all other switching device variants known in the prior art having electromagnetic releases by the use according to the invention of a ferromagnetic shape memory alloy for forming a snap-action body. In particular, a release according to the invention can be designed and operated using a snap-action body consisting of a ferromagnetic shape memory metal given a suitable design of the elastic properties and the type of coupling to the impact armature even without the resetting spring 46, 46a, 46b.

One further refinement is shown in FIGS. 5 to 8.

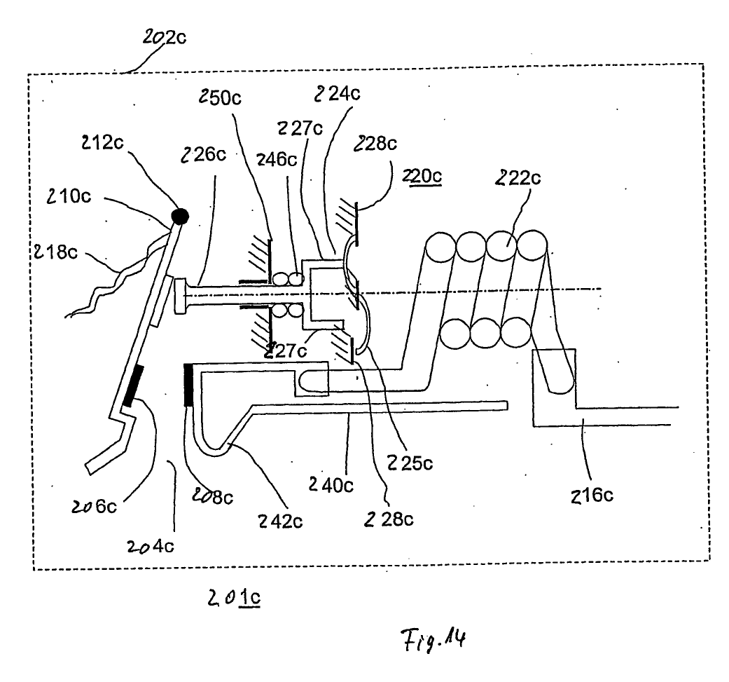

A current path runs between an input clamping piece (not illustrated here) and an output clamping piece 116 via a moveable braided wire 118, a contact lever 110 mounted in a contact-lever mount 112, a contact point 104 comprising a moveable contact piece 106 located on the contact lever 110 and a fixed contact piece 108, and a tripping coil 122. In the switching position shown in FIG. 109, the contact point 104 is closed. A yoke 140 is also connected to the tripping coil 122 and the fixed contact piece 108 via a lug-shaped intermediate piece 142.

The thermal and electromagnetic release 120 comprises the tripping coil 122 and a snap-action disk 124 formed from a ferromagnetic shape memory metal. This snap-action disk is arranged at the front end of the tripping coil 122 such that the snap-action disk center point moves on an imaginary line as an extension of the tripping coil longitudinal axis when it is snapped over. The snap-action disk 124 is held on its outer circumference in a snap-action disk mount 128, which is connected to the housing 102. In the untripped state shown in FIG. 5, its curvature points in the direction of the tripping coil 122. At its center point, the snap-action disk 124 is operatively connected to an impact armature or plunger 126. The operative connection is shown here as an interlocking connection, but force-fitting connections or connections produced by techniques such as soldering, bonding or welding could also alternatively be realized.

The snap-action disk consisting of a ferromagnetic shape memory metal based on nickel, manganese and gallium is located outside the tripping coil 122. Its physical arrangement in relation to the tripping coil 122 is selected such that good thermal and magnetic coupling to the tripping coil 122 is provided. A design of the tripping coil 122 and the magnetic circuit which is suitable for this purpose can be carried out by a person skilled in the art using his normal knowledge in the art and assisted by systematic experiments.

Ferromagnetic shape memory alloys based on nickel, manganese and gallium are known in principle and are available; they are produced and marketed, for example, by the Finnish firm AdaptaMat Ltd. A typical composition of ferromagnetic shape memory alloys for the use according to the invention in switching devices is provided by the structural formula Ni_{65-x-y}Mn₂₀₊ₓGa_{15+y}, where x is between 103 atomic percent and 115 atomic percent, and y is between 3 atomic percent and 112 atomic percent. The ferromagnetic shape memory alloy used here has the property that, in its martensitic phase, that is the phase which the material assumes below the thermal transition temperature, under the influence of an external magnetic field on a microscopic scale a transition between two crystal structure variants of a twin-crystal structure takes place which is macroscopically connected to a change in shape. In the embodiment selected here for the snap-action disk, the change in shape consists in a bend towards the shape of the second bistable snap-action disk position.

The thermal transition temperature in the case of the ferromagnetic shape memory alloys used here is in the region of the ambient temperature and can be adjusted by varying the atomic percent proportions x and y within a bandwidth. The working temperature range within which the thermal and electromagnetic release operates as a purely magnetic release can therefore be adjusted within a bandwidth by selecting the material composition.

When the thermal transition temperature is exceeded, the ferromagnetic shape memory material—even without an external magnetic field—transfers to its austenitic phase. This phase transition is reversible and is likewise associated with a change in shape, which in this case likewise manifests itself as a bend towards the shape of the second bistable snap-action disk position.

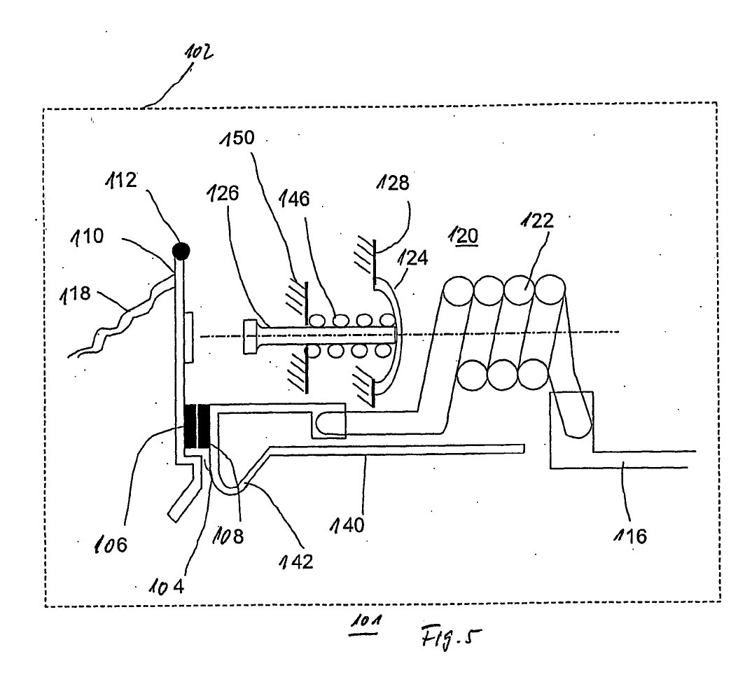

Short-circuit current tripping now takes place in the following manner. If a high short-circuit current flows through the switching device 101 in the event of a short circuit, the snap-action disk bends out of the first bistable position until the dead center point is exceeded, and the direction of curvature of the snap-action disk changes suddenly into the second bistable position. As a result, the plunger 126 forces the moveable contact piece 106 away from the fixed contact piece 108, with the result that the contact point 104 is opened and the switching device is tripped, as illustrated in FIG. 6. The bending of the ferromagnetic shape memory material takes place in this case very rapidly and virtually without any delay. The delay time as the time difference between the occurrence of the short-circuit current and the time at which the dead center point is reached is typically of the order of magnitude of one millisecond.

It is of course possible in this case for tripping to be assisted, as is conventional in switching device technology and is not illustrated here, by a tripping lever which actuates a switching mechanism ensuring the permanent opening of the contact point.

Once the switching device has been tripped, the current path is interrupted and the magnetic field of the tripping coil 122 breaks down again. As a result, the snap-action disk 124 is again moved back into its first bistable position, as a result of which the impact armature 126 is also moved back into the initial position again, as shown in FIG. 109. The contact point 104 is now held permanently in the open position by a switching mechanism.

The thermal overcurrent tripping takes place in the following manner: if the current flowing in the current path through the switching device 101 exceeds its rated value by a higher value and for a longer period of time than is permitted, the snap-action disk 124 is heated, owing to the heat input from the tripping coil 122, to a temperature which is above the thermal transition temperature of the ferromagnetic shape memory metal. As a result, the thermally induced change in shape of the snap-action disk 124 takes place, which in this case again manifests itself as a bend towards the shape of the second bistable snap-action disk position. The interruption in the current path otherwise takes place in the same manner as described above for magnetic tripping.

Electromagnetic and thermal tripping are therefore brought about by a single component. The design of a switching device with a thermal and magnetic release as described is therefore very simple and, owing to the fact that a complete assembly is dispensed with, is more cost-effective than in the case of conventional switching devices.

In order to assist in the back-deformation of the snap-action disk 124 once the magnetic field of the tripping coil 122 has broken down or after cooling to below the thermal transition temperature as a result of the contact opening in the event of tripping, in the embodiment shown in FIGS. 5 and 6 a resetting spring 146 is fitted. In this case, this resetting spring is in the form of a helical spring and surrounds the impact armature 126. However, it could also be in the form of a leaf spring or have another suitable design. The resetting spring 146 is unstressed in the untripped state (FIG. 5). It is supported with one end on a spring mount 50, which is connected to the housing, and with its other end on the central section of the snap-action disk 24. In the event of tripping (FIG. 6), it is compressed by the snap-action disk 24, which has snapped into its second bistable position.

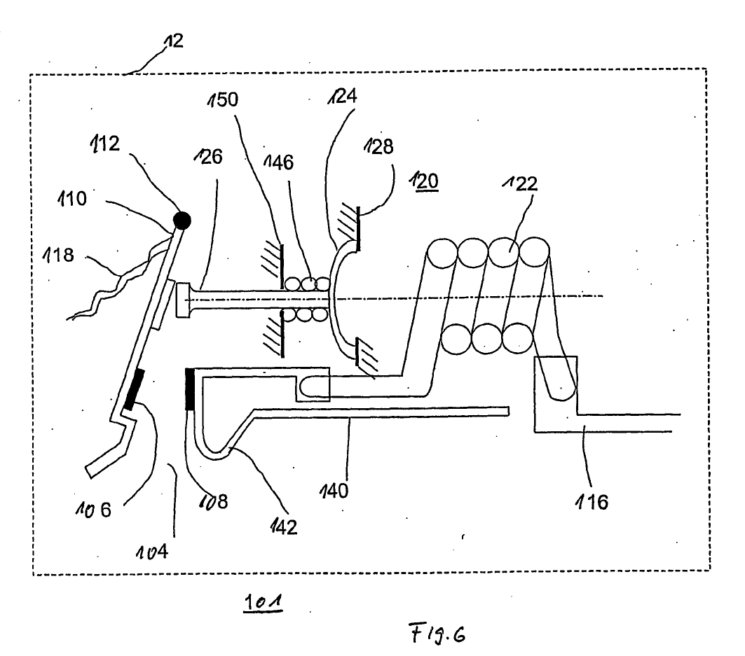

FIG. 7 shows a further embodiment of a thermal and electromagnetic release 120a according to the invention for use in a switching device according to the invention. Identical or functionally identical components or modules are in this case denoted by the same reference numerals as in FIG. 6, in each case supplemented by the letter a.

The tripping coil 122a is in this case wound onto a cylindrical coil former. The coil former consists of a highly thermally conductive and magnetically non-shielding material, for example a ceramic or a suitable plastic. At its end facing the contact point, the coil former has a curvature in the form of a bulge such that, in its interior, a cavity 155a is produced, whose lateral boundary forms the snap-action body mount 128a and in which the snap-action disk 124a is accommodated and mounted. The impact armature 126a is guided such that it can slide in a bushing 158a at the front end of the coil former 156a which faces the contact point. The resetting spring 146a is likewise mounted in the interior of the cavity 155a. The coil former 156a may comprise, for example, two halves which are split in the longitudinal direction along the central plane of the coil former, the snap-action disk with the resetting spring and the impact armature being inserted between the parts of said halves which form the cavity once they have been joined together, before the two halves are assembled to form the coil former 156a.

The coil former 156a is connected to the housing inner wall of the switching device such that it is fixed in position, with the result that the snap-action disk is in this case not mounted in the housing but in the interior of the coil former 156a. This results in a very compact tripping assembly with few individual parts.

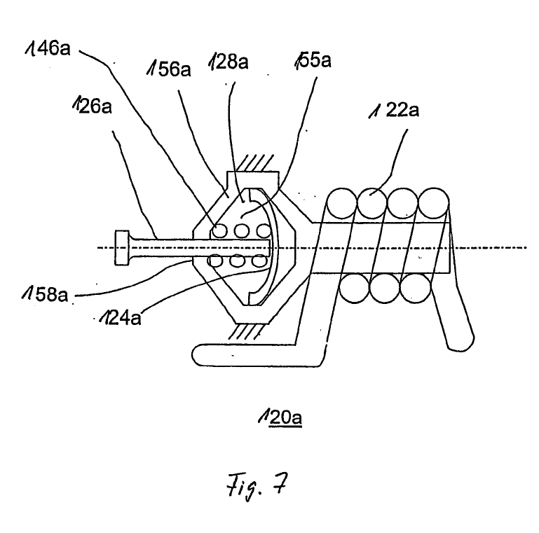

One further embodiment of a thermal and electromagnetic release 120b according to the invention for use in a switching device according to the invention is shown in FIG. 8. Identical or functionally identical components or modules are in this case denoted by the same reference numerals as in FIG. 6 or 5, in each case supplemented by the letter b. The embodiment shown in FIG. 7 differs from that shown in FIG. 5 to the extent that, in the former case, the cavity 155b formed in the coil former 156b and therefore the snap-action disk 124b are located in the interior of the tripping coil 122b.

The exemplary embodiments described and illustrated in FIGS. 5 to 8 are an exemplary non-exclusive representation of possible switching devices according to the invention using a thermal and electromagnetic release having a snap-action body consisting of a ferromagnetic shape memory alloy. It is also possible for switching devices according to the invention to be produced from all other switching device variants known in the prior art having thermal and electromagnetic releases by the use according to the invention of a ferromagnetic shape memory alloy for forming a snap-action body. In particular, a release according to the invention can be designed and operated using a snap-action body consisting of a ferromagnetic shape memory metal given a suitable design of the elastic properties and the type of coupling to the impact armature even without the resetting spring 146, 146a, 146b.

FIG. 9 shows a schematic illustration of a switching device 201 having a housing 202 and a thermal and electromagnetic release 220 in the untripped state. FIG. 10 shows the switching device shown in FIG. 9 in the tripped state, in which case identical or functionally similar assemblies or parts are denoted by the same reference numerals.

A current path runs between an input clamping piece (not illustrated here) and an output clamping piece 216 via a moveable braided wire 218, a contact lever 210, which is mounted in a contact-lever mount 212, a contact point 204 comprising a moveable contact piece 206 located on the contact lever 210 and a fixed contact piece 208, and a tripping coil 222. In the switching position shown in FIG. 205, the contact point 204 is closed. A yoke 240 is also connected to the tripping coil 222 and the fixed contact piece 208 via a lug-shaped intermediate piece 242.

The thermal and electromagnetic release 220 comprises the tripping coil 222, a snap-action disk 224 formed from a ferromagnetic shape memory metal and a second snap-action disk 225 formed from a thermal shape memory metal. The second snap-action disk 225 could also consist of a bimetallic strip or a ferromagnetic shape memory metal having a different composition.

Both snap-action disks 224, 225 are arranged at the front end of the tripping coil 222 such that the snap-action disk center points move on an imaginary line as an extension of the tripping coil longitudinal axis when they are snapped over. The snap-action disk 225 is held on its outer circumference in a snap-action disk mount 228, which is connected to the housing 202. In the untripped state shown in FIG. 9, the curvature of the two snap-action disks points in the direction of the tripping coil 222. At its center point, the snap-action disk 225 is operatively connected to an impact armature 226. The operative connection is shown here as an interlocking connection, but force-fitting connections or connections produced by techniques such as soldering, bonding or welding could also alternatively be realized.

The two snap-action disks 224, 225 are located in their rest position. They bear against one another with their broad sides such that, as a result, a force-fitting operative connection is produced between them. When the first snap-action disk 224 snaps over, it takes the second snap-action disk 225 with it, and, as a result of the second snap-action disk 225 snapping over, the impact armature is moved towards the switching lever 210 and opens the contact point 204.

The physical arrangement of the two snap-action disks 224, 225 in relation to the tripping coil 222 is selected such that good thermal and magnetic coupling to the tripping coil 222 is provided. A design of the tripping coil 222 and the magnetic circuit which is suitable for this purpose can be carried out by a person skilled in the art using his normal knowledge in the art and assisted by systematic experiments.

Ferromagnetic shape memory alloys based on nickel, manganese and gallium are known in principle and are available; they are produced and marketed, for example, by the Finnish firm AdaptaMat Ltd. A typical composition of ferromagnetic shape memory alloys for the use according to the invention in switching devices is provided by the structural formula Ni_{65-x-y}Mn₂₀₊ₓGa_{15+y}, where x is between 3 atomic percent and 15 atomic percent, and y is between 3 atomic percent and 12 atomic percent. The ferromagnetic shape memory alloy used here has the property that, in its martensitic phase, that is the phase which the material assumes below the thermal transition temperature, under the influence of an external magnetic field on a microscopic scale a transition between two crystal structure variants of a twin-crystal structure takes place which is macroscopically connected to a change in shape. In the embodiment selected here for the snap-action disk, the change in shape consists in a bend towards the shape of the second bistable snap-action disk position.

The thermal transition temperature in the case of the ferromagnetic shape memory alloys used here is in the region of the ambient temperature and can be adjusted by varying the atomic percent proportions x and y within a bandwidth. The working temperature range within which the thermal and electromagnetic release operates as a purely magnetic release can therefore be adjusted within a bandwidth by selecting the material composition.

When the thermal transition temperature is exceeded, the ferromagnetic shape memory material—even without an external magnetic field—transfers to its austenitic phase. This phase transition is reversible and is likewise associated with a change in shape, which in this case likewise manifests itself as a bend towards the shape of the second bistable snap-action disk position.

Short-circuit current tripping now takes place in the following manner. If a high short-circuit current flows through the switching device 201 in the event of a short circuit, the first snap-action disk 224, under the influence of the magnetic field of the tripping coil owing to the magnetic shape memory effect, bends out of the first bistable position until the dead center point is exceeded, and the direction of curvature of the snap-action disk 224 changes suddenly into the second bistable position. As a result, the second snap-action disk 225 is also concomitantly bent until it likewise snaps over and, as a result, the plunger 226 forces the moveable contact piece 106 away from the fixed contact piece 208, with the result that the contact point 104 is opened and the switching device is tripped, as illustrated in FIG. 10. The bending of the ferromagnetic shape memory material takes place in this case very rapidly and virtually without any delay. The delay time as the time difference between the occurrence of the short-circuit current and the time at which the dead center point is reached is typically of the order of magnitude of one millisecond.

The two snap-action disks 224, 255 could of course also have a distance from one another and interact via a mechanical coupling element, for example a short rod.

It is of course possible in this case for tripping to be assisted, as is conventional in switching device technology and is not illustrated here, by a tripping lever which actuates a switching mechanism ensuring the permanent opening of the contact point.

Once the switching device has been tripped, the current path is interrupted and the magnetic field of the tripping coil 222 breaks down again. As a result, the snap-action disk 224 is again moved back into its first bistable position. In order to assist in the back-deformation of the second snap-action disk 225 as well once the magnetic field of the tripping coil 222 has broken down as a result of the contact opening in the event of tripping, in the embodiment shown in FIGS. 9 and 10 a resetting spring 246 is fitted. In this case, this resetting spring is in the form of a helical spring and surrounds the impact armature 226. However, it could also be in the form of a leaf spring or have another suitable design. The resetting spring 246 is unstressed in the untripped state (FIG. 9). It is supported with one end on a spring mount 250, which is connected to the housing, and with its other end on the central section of the second snap-action disk 225. In the event of tripping (FIG. 10), it is compressed by the snap-action disk 224, which has snapped into its second bistable position.

Thermal overcurrent tripping takes place in the following manner: if the current flowing in the current path through the switching device 201 exceeds its rated value by a higher value and for a longer period of time than is permitted, the two snap-action disks 224, 225 are heated, owing to the heat input from the tripping coil 222, to a temperature which is below the thermal transition temperature of the ferromagnetic shape memory metal of the first snap-action disk 224, but above the thermal transition temperature of the material of the second snap-action disk 225. As a result, the thermally induced change in shape of the second snap-action disk 225 takes place, which in this case again manifests itself as a bend towards the shape of the second bistable snap-action disk position. The interruption in the current path otherwise takes place in the same manner as described above for magnetic tripping.

Electromagnetic and thermal tripping are therefore brought about by a single component. The design of a switching device with a thermal and magnetic release as described is therefore very simple and, owing to the fact that a complete assembly is dispensed with, is more cost-effective than in the case of conventional switching devices.

FIG. 11 shows a further embodiment of a thermal and electromagnetic release 220a according to the invention for use in a switching device according to the invention. Identical or functionally identical components or modules are in this case denoted by the same reference numerals as in FIG. 9, in each case supplemented by the letter a.

The tripping coil 222a is in this case wound onto a cylindrical coil former. The coil former consists of a highly thermally conductive and magnetically non-shielding material, for example a ceramic or a suitable plastic. At its end facing the contact point, the coil former has a curvature in the form of a bulge such that, in its interior, a cavity 255a is produced, whose lateral boundary forms the snap-action body mount 228a and in which the snap-action disks 224a, 225a are accommodated and mounted. The impact armature 226a is guided such that it can slide in a bushing 258a at the front end of the coil former 256a which faces the contact point. The resetting spring 246a is likewise mounted in the interior of the cavity 255a. The coil former 256a may comprise, for example, two halves which are split in the longitudinal direction along the central plane of the coil former, the snap-action disks with the resetting spring and the impact armature being inserted between the parts of said halves which form the cavity once they have been joined together, before the two halves are assembled to form the coil former 256a.

The coil former 256a is connected to the housing inner wall of the switching device such that it is fixed in position, with the result that the snap-action disks are in this case not mounted in the housing but in the interior of the coil former 256a. This results in a very compact tripping assembly with few individual parts.

One further embodiment of a thermal and electromagnetic release 220b according to the invention for use in a switching device according to the invention is shown in FIG. 12. Identical or functionally identical components or modules are in this case denoted by the same reference numerals as in FIG. 9 or 11, in each case supplemented by the letter b. The embodiment shown in FIG. 12 differs from that shown in FIG. 11 to the extent that, in the former case, the cavity 255b formed in the coil former 256b and therefore the snap-action disks 224b, 225b are located in the interior of the tripping coil 222b.

One further embodiment of a switching device according to the invention is shown in FIGS. 13 and 14. Identical or functionally identical components and parts in this case have the same reference numerals as in FIGS. 9 and 10, in each case supplemented by the letter c.

FIG. 13 shows a schematic illustration of a switching device 201c having a housing 202c and a thermal and electromagnetic release 220c in the untripped state. FIG. 14 shows the switching device shown in FIG. 13 in the tripped state.

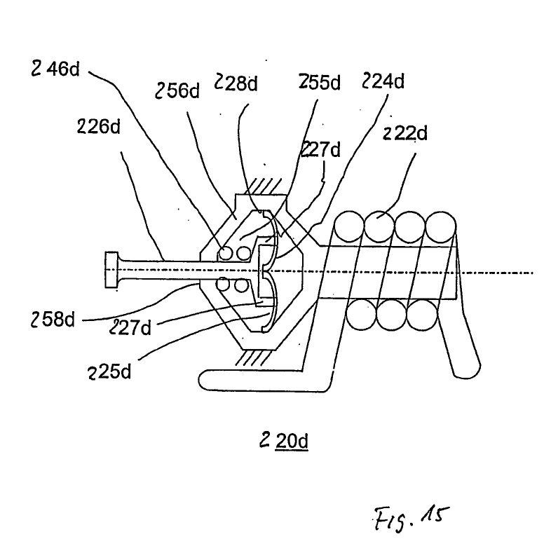

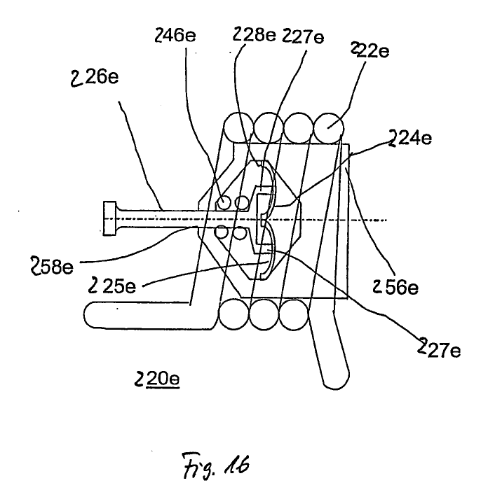

The difference between the embodiment shown in FIGS. 13 and 14 and that shown in FIGS. 201 and 202 consists in the fact that, in the former case, the two snap-action disks 224c and 225c are connected at their outer edge and each of the two snap-action disks 224c, 225c is operatively connected to the impact armature 226c separately. For this purpose, the impact armature 226c is split in the form of a fork into two impact armature protrusions 227c at its end facing away from the contact lever 210c, of which protrusions in each case one is connected in a force-fitting but detachable manner to one of the two snap-action disks 224c and 225c, in each case in their central region.

In the case of magnetic short-circuit current tripping (FIG. 14), the magnetically activated snap-action disk 224c snaps over and, via the impact armature protrusion 227c, moves the impact armature 226c so as to open the contact point 204c. Resetting takes place under the action of a resetting spring 246c, which acts on a spring mount 250c, which is connected to the housing 202c, and on the impact armature 226c.

In the case of thermal overcurrent tripping, the snap-action disk 225c, which can be activated thermally, would snap over and bring about tripping in a similar manner.

The embodiment shown in FIG. 15 corresponds to that shown in FIG. 7, and that shown in FIG. 16 corresponds to that shown in FIG. 12, with the difference that, in the former case, the two snap-action disks 224d and 224e, respectively, and 225d and 225e, respectively are connected at their outer edges and each of the two snap-action disks 224d and 224e, respectively, 225d and 225e, respectively, are operatively connected to the impact armature 226d and 226e, respectively, separately via the impact armature protrusions 227d and 227e, respectively.

The exemplary embodiments described and illustrated in FIGS. 9 to 16 are an exemplary, non-exclusive representation of possible switching devices according to the invention using a thermal and electromagnetic release having a snap-action body consisting of a ferromagnetic shape memory alloy. It is also possible for switching devices according to the invention to be produced from all other switching device variants known in the prior art having thermal and electromagnetic releases by the use according to the invention of a ferromagnetic shape memory alloy for forming a snap-action body.

In one further embodiment, the snap-action body 224 can be produced from a material which has a combined thermal and magnetic shape memory effect, the snap-action body, both under the influence of the magnetic field of the tripping coil 222 in the event of a short-circuit current and under the influence of a change in temperature brought about by overcurrent, being driven into two stable positions.

### LIST OF REFERENCE SYMBOLS

1 Switching device
2 Housing
4 Contact point
6 Moveable contact piece
8 Fixed contact piece
10 Contact lever
12 Contact-lever mount
18, 18′ Moveable braided wire
20, 20a, 20b Electromagnetic release
22, 22a, 22b Tripping coil
24, 24a, 24b Snap-action body
26, 26a, 26b Impact armature
28, 28a, 28b Snap-action disk mount
34 Slide
35 Cutout in the slide
40 Yoke
42 Intermediate piece
44 Bimetallic strip
44′ Moveable end of the bimetallic strip
44″ Fixed end of the bimetallic strip
46, 46a, 46b Resetting spring
48 Bimetallic holder
50 Spring mount
55a, 55b Cavity
56, 56a, 56b Coil former
58a, 58b Bushing
S, B Directional arrow

1. A switching device having a housing and having at least one contact point, which comprises a fixed and a moveable contact piece, and having an electromagnetic and/or possibly thermal release, which has a tripping coil and a plunger, wherein the electromagnetic release comprises at least one snap-action body, which is operatively connected to the plunger and consists of a material having a magnetic shape memory effect, the snap-action body, under the influence of the magnetic field of the tripping coil in the event of a short-circuit current, being switched over into two bistable positions.

2. The switching device as claimed in claim 1, wherein the release comprises a material having both a magnetic and a thermal shape memory.

3. The switching device as claimed in claim 1, wherein the snap-action body is formed from a ferromagnetic shape memory alloy consisting of nickel, manganese and gallium.

4. The switching device as claimed in claim 1, wherein the snap-action body is in the form of a snap-action disk and is held on its outer circumference in a snap-action disk mount, which is connected to the housing.

5. The switching device as claimed in claim 1, wherein the snap-action body is in the form of a snap-action disk and is held within a coil former, which bears the tripping coil.

6. The switching device as claimed in claim 1, wherein the snap-action disk is connected, in the region of its center, to the impact armature in a force-fitting or interlocking manner.

7. The switching device as claimed in claim 1, wherein the snap-action body is fitted outside the tripping coil in its vicinity.

8. The switching device as claimed in claim 1, wherein the snap-action body is surrounded by the tripping coil.

9. The switching device as claimed in claim 1, wherein the snap-action element is operatively connected to a resetting spring, which assists in switching the snap-action element over into the two bistable positions.

10. The switching device as claimed in claim 1, having a thermal release, wherein the thermal and electromagnetic release comprises two snap-action bodies which are operatively connected to the plunger, one snap-action body consisting of a material having a magnetic shape memory effect, and the other snap-action body consisting of a bimetallic strip or of a material having a thermal shape memory effect or of a material having a combined thermal and magnetic shape memory effect, one snap-action body, under the influence of the magnetic field of the tripping coil in the event of a short-circuit current, and the other snap-action body, under the influence of a temperature increase brought about by overcurrent, being switched over into two bistable positions.

11. The switching device as claimed in claim 10, wherein one snap-action body is formed from a ferromagnetic shape memory alloy consisting of nickel, manganese and gallium.

12. The switching device as claimed in claim 10, wherein one snap-action body and the other snap-action body are formed from ferromagnetic shape memory alloys consisting of nickel, manganese and gallium and having different compositions.

13. The switching device as claimed in claim 10, wherein one snap-action body and the other snap-action body are in the form of snap-action disks.

14. The switching device as claimed in claim 10, wherein one snap-action body and the other snap-action body are surrounded by the tripping coil.

15. The switching device as claimed in claim 10, wherein one snap-action body and the other snap-action body are arranged outside the tripping coil and in its vicinity.

16. The switching device as claimed in claim 10, wherein one snap-action body and the other snap-action body are introduced and held within a coil former, which bears the tripping coil.

17. The switching device as claimed in claim 1, wherein one snap-action body and the other snap-action body are operatively connected to one another.

18. The switching device as claimed in claim 1, wherein each of the two snap-action bodies is operatively connected to the impact armature separately.

19. The switching device as claimed in claim 1, wherein at least one of the two snap-action elements is operatively connected to a resetting spring, which assists in switching the snap-action element over into the two bistable positions.

20. The switching device as claimed in claim 1, wherein the impact armature is operatively connected to a resetting spring, which assists in resetting the impact armature.

21. The use of a material having a magnetic shape memory effect in an electromagnetic release, which has a tripping coil and an impact armature, for a switching device, wherein the snap-action body of the electromagnetic release, which comprises a snap-action body, is formed from the material having a magnetic shape memory effect, the snap-action body, under the influence of the magnetic field of the tripping coil in the event of a short-circuit current, being switched over into two bistable positions.

22. The use of a material having a magnetic shape memory effect for short-circuit current tripping as claimed in claim 21, consisting of a ferromagnetic shape memory alloy consisting of nickel, manganese and gallium.

23. The use of a material having a combined thermal and magnetic shape memory effect in a thermal and electromagnetic release, which has a tripping coil and an impact armature, for a switching device, the thermal and electromagnetic release having a snap-action body consisting of the material having the combined thermal and magnetic shape memory effect, and, the snap-action body, both under the influence of the magnetic field of the tripping coil in the event of a short-circuit current and under the influence of a temperature increase brought about by overcurrent, being switched over into two bistable positions.

24. The use of a material having a combined thermal and magnetic shape memory effect as claimed in claim 23, consisting of a ferromagnetic shape memory alloy consisting of nickel, manganese and gallium.

25. The use of a material having a combined thermal and magnetic shape memory effect for overcurrent and short-circuit current tripping in a switching device comprising a contact point and a thermal and electromagnetic release, the thermal and electromagnetic release having a snap-action body consisting of the material having the combined thermal and magnetic shape memory effect, and the snap-action body, both under the influence of the magnetic field of the tripping coil in the event of a short-circuit current and under the influence of a temperature increase brought about by overcurrent, being switched over into two bistable positions.

26. The use of a material having a combined thermal and magnetic shape memory effect for overcurrent and short-circuit current tripping as claimed in claim 11, consisting of a ferromagnetic shape memory alloy consisting of nickel, manganese and gallium.

27. The use of a material having a combined thermal and magnetic shape memory effect in a thermal and electromagnetic release, which has a tripping coil and an impact armature, for a switching device, wherein the thermal and magnetic release comprises two snap-action bodies, which are operatively connected to the impact armature, and one snap-action body consists of the material having a magnetic shape memory effect, and the other snap-action body consists of a bimetallic strip or of a material having a thermal shape memory effect, one snap-action body, under the influence of the magnetic field of the tripping coil in the event of a short-circuit current, and the other snap-action body, under the influence of a temperature increase brought about by overcurrent, being switched over into two bistable positions.

28. The use of a material having a combined thermal and magnetic shape memory effect as claimed in claim 27, consisting of a ferromagnetic shape memory alloy consisting of nickel, manganese and gallium.

29. The use of a material having a combined thermal and magnetic shape memory effect for overcurrent and short-circuit current tripping in a switching device comprising a contact point and a thermal and electromagnetic release, wherein the switching device comprises two snap-action bodies, which are operatively connected to the impact armature, and one snap-action body consists of the material having a magnetic shape memory effect, and the other snap-action body consists of a bimetallic strip, one snap-action body, under the influence of the magnetic field of the tripping coil in the event of a short-circuit current, and the other snap-action body, under the influence of a temperature increase brought about by overcurrent, being switched over into two bistable positions.

30. The use of a material having a combined thermal and magnetic shape memory effect for overcurrent and short-circuit current tripping as claimed in claim 14, consisting of a ferromagnetic shape memory alloy consisting of nickel, manganese and gallium.
